(19) United States
(12) Patent Application Publication
(10) Pub. No.: US 2022/0328068 A1
(43) Pub. Date: Oct. 13, 2022

(54) ACTUATION OF SUSPENSION FOR OFF RAMP Z-MOTION FOR AN ELEVATOR DRIVE

(71) Applicant: Seagate Technology LLC, Fremont, CA (US)

(72) Inventors: Brett R Herdendorf, Mound, MN (US); Riyan Alex Mendonsa, Edina, MN (US); Krishnan Subramanian, Shakopee, MN (US)

(73) Assignee: Seagate Technology LLC, Fremont, CA (US)

(21) Appl. No.: 17/809,062

(22) Filed: Jun. 27, 2022

Related U.S. Application Data
(63) Continuation-in-part of application No. 17/728,415, filed on Apr. 25, 2022.
Application No. 17/728,415 is a continuation-in-part of application No. 17/172,684, filed on Feb. 10, 2021, now Pat. No. 11,315,592.
(60) Provisional application No. 63/215,930, filed on Jun. 28, 2021.

(51) Int. Cl. G11B 5/48; G11B 5/54

(52) U.S. Cl. CPC G11B 5/4813; G11B 5/4853; G11B 5/54; G11B 2220/2516

(57) ABSTRACT

A data storage device with at least one data storage disc and a head stack assembly. The head stack assembly includes an actuator mechanism and at least one recording head supported by a suspension assembly. The suspension assembly includes a load beam and an actuator arm and at least one actuator is disposed on at least one surface of the load beam or the actuator arm. The at least one actuator is configured to deflect the at least one recording head in a vertical direction relative to the recordable surface of the storage disc.

This application claims benefit to U.S. Provisional Patent Application Ser. No 63/215,930 filed Jun. 28, 2021, entitled “Actuation of suspension for off ramp Z-motion for an elevator drive”. This application is also a continuation-in-part of U.S. patent application Ser. No. 17/728,415 filed Apr. 25, 2022, entitled “Adjusting HGA-z-height via HSA elevator using head/actuator feedback” which is a continuation-in-part of U.S. patent application Ser. No. 17/172,684, filed Feb. 10, 2021 (now U.S. Pat. No. 11,315,592), entitled “Adjusting HGA z-height via HSA elevator using head/actuator feedback”; all of which are hereby incorporated by reference in their entirety.

### BACKGROUND

Hard disk drives (HDDs) are commonly used in computer systems to facilitate storage of large amounts of data. Such hard disk drives utilize magnetic media typically comprising rotating data storage disks. One or more read/write heads comprising a head assembly may be provided and may be moved relative to the rotating data storage disks to facilitate reading data from and writing data to the data storage disks. The head assembly is typically supported by an actuator arm that may be moved relative to the rotating data storage disks to access different tracks on the data storage disks. The heads may be supported above the rotating magnetic disks by the actuator arm on an air bearing at a distance referred to as a flying height during normal operation when the heads are reading data and writing data to data tracks on the data storage disks. In some HDDs, a number of heads is equal to a number of disk surfaces, and the heads are rotated for positioning over their corresponding disk surfaces. There is typically no up/down movement of the heads in such HDDs. However, in an “elevator” drive, for example, the number of heads employed is less than the number of surfaces, and a head stack assembly (HSA) including the fewer number of heads is moved up/down to enable a same head to read from multiple disk surfaces.

In some cases, it may be necessary to move the head assembly away from the data storage disks. Operations may occur in which the head assembly may be moved away from the magnetic disks for various reasons such as during initial manufacturing of the drive, for protection of the head and/or magnetic disks during idle times of the drive, or for other reasons. Head support ramps have traditionally been provided that provide a gradual transition between the flying height of the head assembly above the rotating storage disks and a park location of the heads away from the disks. In some cases, a split ramp may be used. A split ramp includes a rotatable portion adjacent to the outer diameter (OD) of the discs and a portion that moves in a z-direction that is adjacent to the rotatable portion of the ramp. However, the portion that moves in a z-direction may not be sufficiently compact to allow for packaging within a housing of a disk drive. This is particularly relevant in view of efforts to continuously reduce cost and complexity as well as size and/or footprint area of drives.

### SUMMARY

The present disclosure describes a data storage system configured with a ramp assembly with actuation of suspension for off-ramp z-motion (e.g., vertical motion) in an elevator drive. The data storage system includes a ramp assembly which includes a rotatable portion such that actuation of the ramp between an engaged position and a disengaged position relative to the disks may be accomplished in a relatively small spatial envelope. The data storage system also includes a rotatable actuator arm and an elevator configured to move the rotatable actuator arm in a vertical direction. A load beam is coupled to the actuator arm and a recording head is coupled to the load beam. The rotatable actuator arm and load beam each include one or more actuators that can be used for off-ramp z-motion.

In one example, a data storage device includes at least one data storage disc with a recordable surface, and a head stack assembly comprising an actuator mechanism. At least one recording head is supported by a suspension assembly. The suspension assembly includes a load beam and an actuator arm. At least one actuator is disposed on at least one surface on at least one of the load beam, or the actuator arm. The at least one actuator is configured to deflect the at least one recording head in a vertical direction relative to the recordable surface of the at least one data storage disc.

In another example, a method of actuation of off-ramp z-motion in an elevator drive. the method comprising the steps of receiving a command to change a disc and moving at least one recording head away from a disc surface to a recording head support ramp assembly. The at least one recording head is deflected in a vertical direction relative to the disc surface by at least one actuator disposed on at least one surface of at least one of a load beam or an actuator arm. The at least one recording head is rotated away from the disc.

These and other features and aspects of various examples may be understood in view of the following detailed discussion and accompanying drawings.

### BRIEF DESCRIPTION OF THE DRAWINGS

FIG. 1 is a schematic illustration of a data storage device according to various aspects of the present disclosure.

FIG. 2 is a partial top-down view of an example data storage device, according to various aspects of the present disclosure.

FIG. 3A is a schematic illustration of a top-down view of an example head stack assembly, according to various aspects of the present disclosure. FIG. 3B is a schematic illustration of a bottom view of an example head stack assembly, according to various aspects of the present disclosure. FIGS. 3C and 3D are schematic illustrations of side views of example head-stack assemblies, according to various aspects of the present disclosure.

FIG. 4 shows a flow diagram illustrating an example set of steps of actuation of off-ramp z-motion in an elevator drive, according to various aspects of the present disclosure.

FIG. 5 is a simplified schematic illustration of an end-view of a portion of an example data storage device, according to various aspects of the present disclosure.

### DETAILED DESCRIPTION

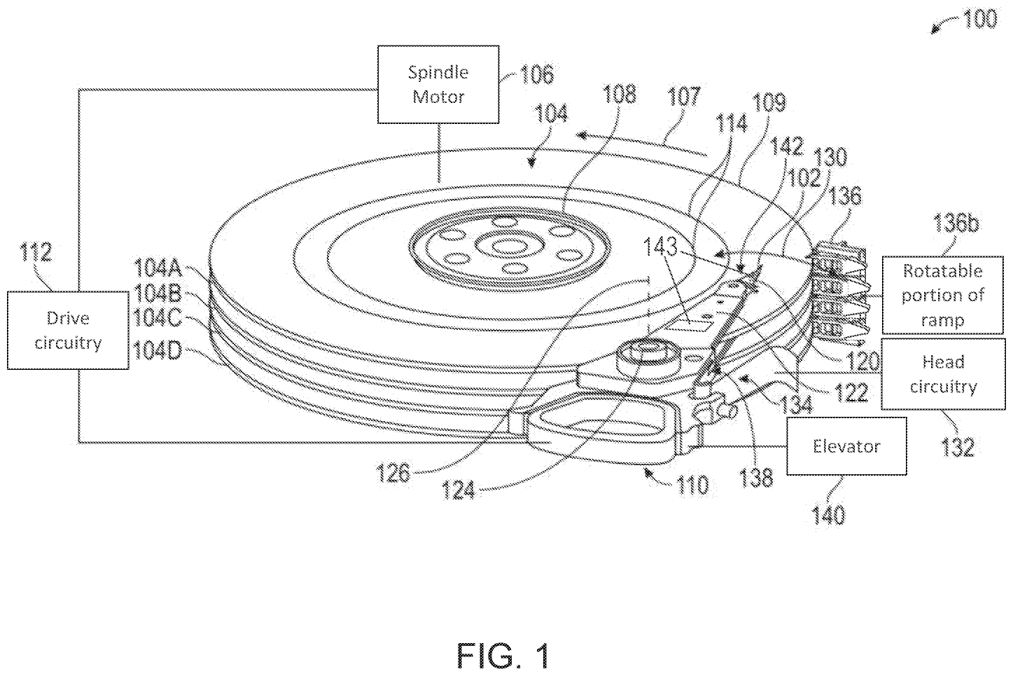

FIG. 1 is a schematic illustration of a data storage device 100 including storage media, recording heads for reading data from and/or writing data to the storage media and a ramp for supporting the heads. In data storage device 100, a plurality of recording heads 102 may be positioned over storage media 104 to read data from and/or write data to data storage media 104. In the example shown in FIG. 1, storage media 104 are rotatable data storage discs, with each disc, 104 having opposing surfaces that serve as data storage surfaces. For read and write operations, a spindle motor 106 (illustrated schematically) rotates disc 104 as illustrated by arrow 107. Actuator mechanism 110 positions recording heads 102 relative to data tracks 114 on rotating disc 104 between inner diameter (ID) 108 and outer diameter (OD) 109. Both spindle motor 106 and actuator mechanism 110 are connected to and operated through drive circuitry 112 (schematically shown). Each of recording heads 102 is coupled to actuator mechanism 110 through a suspension assembly which includes load beam 120 connected to actuator arm 122 of actuator mechanism 110. Connection of load beam 120 to actuator arm 122 may be through a swage connection. Actuator mechanism 110 is rotationally coupled to a frame or deck (not shown) through bearing 127 to rotate about axis 126. Rotation of actuator mechanism 110 moves recording heads 102 in a cross-track direction as illustrated by arrow 130. Each of recording heads 102 includes one or more transducer elements (not shown) coupled to head circuitry 132 (illustrated schematically) through flex circuit 134.

In general, in order to keep recording heads 102 from landing on discs 104 in a data storage device 100 when, for example, power is removed from data storage device 100, recording head support ramp assembly 136 is provided adjacent to OD 109 of discs 104. Recording head support ramp assembly 136 may also prevent recording heads 102 from colliding with outer edges of discs 104 during load and unload operations.

In data storage device 100 a number or recording heads 102 is less than a number of disc 104 surfaces. In the example shown in FIG. 1, data storage device 100 includes 4 discs 104A, 104B, 104C, 104D, with a total of 8 data storage surfaces, and two recording heads 102. Each of the two recording heads 102 is coupled to actuator mechanism 110 through a suspension assembly which includes load beam 120. Load beam 120 is connected to actuator arm 122. Actuator mechanism 110, load beams 120 and actuator arms 122 are collectively referred to as the head stack assembly (HSA) 138.

In data storage device 100 of FIG. 1, HSA 138 may be moved along axis 126 to different positions under motive of elevator 140, which is schematically shown in FIG. 1. In an uppermost position shown in FIG. 1, the two recording heads 102 interact with upper and lower data storage surfaces of disc 104A. In other positions (not shown), which are below the uppermost position, the same two recording heads 102 interact with data storage surfaces of discs 104B, 104C and 104D.

In one example, a base of elevator 140 may be driven up and down by a coil and a magnet (not shown) with hard stops at both ends that limit the extent of upward and downward movement of HSA 138. In general, any suitable driving mechanism may be used to move elevator 140 up and down. Examples of drivers for Z direction motion of elevator 140 include a ball screw with an internal motor, a voice coil motor, an inchworm style brake crawler, a linear motor, a shape memory alloy-based actuator, or a combination of the above.

In other examples, to enable the up/down movement of the HSA 138, recording head support ramp assembly 136 is designed as a split ramp with a stationary portion and a moveable portion (not shown). In some examples, elevator 140 does not directly move the moveable ramp portion; rather, the moveable ramp is temporarily fixed to actuator arm 122 to move therewith as the elevator 140 directly moves the actuator arm 122 up and down. Recording head support ramp assembly 136 supports recording head end 142 of HSA 138 when HSA 138 is rotated away from data storage disc(s) 104. Supporting recording head end 142 of HSA 138 protects recording heads 102 from colliding with one another when HSA 138 is rotated away from storage disc(s) 104. In some examples, recording head support ramp assembly 136 may be moveable away from the OD 109 of discs 104 by way of the rotatable portion of ramp 136b. Further details of a split ramp with a stationary portion and a moveable portion may be found in U.S. Pat. No. 11,348,610B1, filed on 1 Feb. 2021 and issued on 21 May 2022, and entitled “Moveable ramp with arm engaging bracket for an elevator drive on a magnetic disc recording device”, the contents of which are hereby incorporated by reference in its entirety.

To enable fine vertical movement of recording heads 102, actuators 143 located on actuator arm 122 and load beam 120 can be used. Actuators 143 can include any type of device capable of fine vertical movement of recording heads 102. This detailed description may refer to an actuator element as a piezoelectric element, which is one type of suitable actuator element. Other types of actuator elements are also suitable and include, but are not limited to, magnetic or shape memory alloys, or thermal bimetallics.

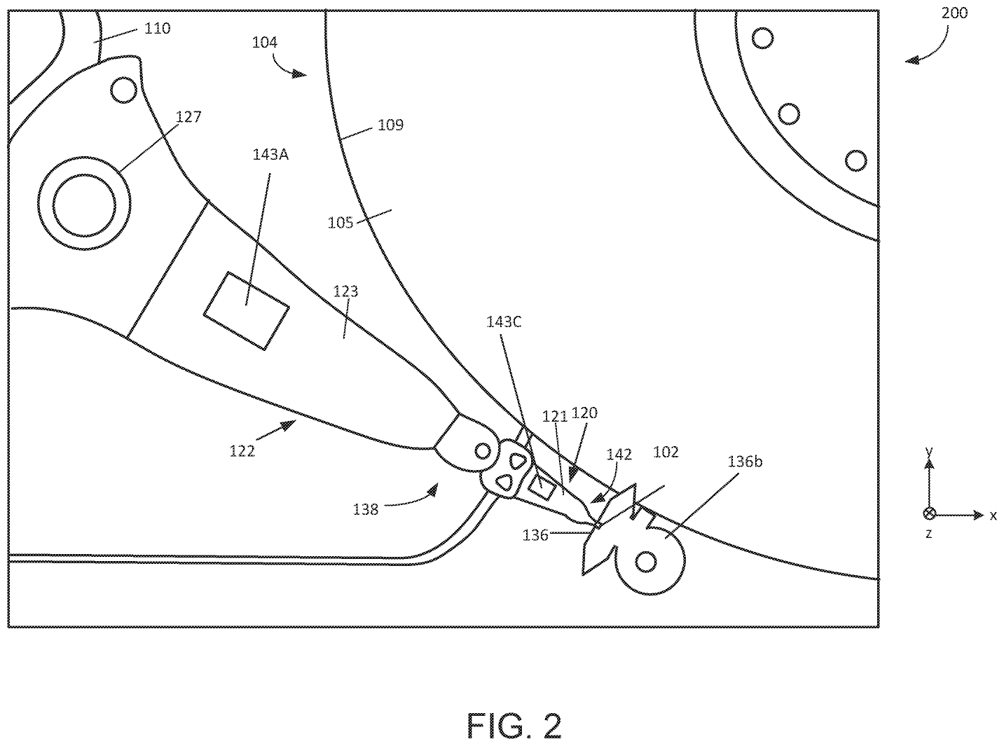

FIG. 2 is a partial top-down view of an example data storage device, according to various aspects of the present disclosure. Data storage device 200 includes a head stack assembly 138, recording head support ramp assembly 136, rotatable portion of ramp 136b, and disc 104. Head stack assembly 138 includes actuator mechanism 110, actuator arm 122, bearing 127, load beam 120 and recording heads 102.

In general, in order to keep recording heads 102 from landing on discs 104 in a data storage device 100 when, for example, power is removed from data storage device 100, recording head support ramp assembly 136 is provided adjacent to OD 109 of discs 104. Recording head support ramp assembly 136 may also prevent recording heads 102 from colliding with outer edges of discs 104 during load and unload operations.

In some examples, recording head support ramp assembly 136 extends towards the interior of discs 104, a distance that spans the OD 109 of the discs 104. This presents several disadvantages. Notably, as recording head support ramp assembly 136 overhangs disc 104, the tracks of the disc 104 near OD 109 may be obscured by recording head support ramp assembly 136, preventing the recoding head 102 from accessing these tracks near OD 109 of the disc 104. This limits the storage capacity of disc 104. As the obscured tracks of disc 104 may be near the outer diameter, the loss of such tracks may constitute a loss of 5% or more of the total storage capacity of data storage device 100.

In some examples, a rotatable portion of ramp 136b is provided as shown in FIG. 2. Rotatable portion of ramp 136b may facilitate a number of benefits relative to traditional static overhung ramps and/or prior proposed retractable ramp solutions. Such benefits may be further appreciated with reference to U.S. patent application Ser. No. 17/196,192, filed on 9 Mar. 2021, and entitled “Rotating ramp with retraction capability for a disk drive”, the contents of which are hereby incorporated by reference in its entirety.

In the example of FIG. 2, HSA 138 also includes actuators 143A and 143C (collectively, actuators 143) located on a top surface 123 of actuator arm 122 and a top surface 121 of load beam 120, respectively. While actuator mechanism 110 provides relatively coarse positioning of recording heads 102 at the surface of disc 104, actuators 143 can provide relatively fine positioning of recording heads 102 at the surface of magnetic media in an x-y plane or in a z-direction. For example, when activated in an x-y plane, actuators 143 can aid in servo tracking during the reading and writing of data to disc 104.

Actuators 143 can also be configured to deflect recording heads 102 in a vertical direction relative to the recordable surface 105 of disc 104. In some examples, deflecting recording heads 102 in a vertical direction relative to the recordable surface 105 of disc 104 can protect heads 102 from colliding with one another during off-ramp motion. In other examples, deflecting recording heads 102 in a vertical direction relative to the recordable surface 105 of disc 104 can improve head-media separation capability.

In some scenarios, feedback signals obtained from actuators 143C on load beam 120 may be obtained by feedback circuitry (not shown) and provided to actuator 143A which may responsively control deflection of recording heads 102 in a z-direction.

In the example of FIG. 2, actuators 143 may be piezoelectric actuators. Piezoelectric actuators convert an electrical signal into controlled physical displacements. In the example of FIG. 2, a single actuator is disposed on each of actuator arm 122 and load beam 120. In the example of FIG. 2, actuators 143 are shown on top surface 123 of actuator arm 122 and top surface 121 of load beam 120. In some examples, actuators (e.g., actuators 143) may be disposed on a bottom surface (not shown) of actuator arm 122 or a bottom surface (not shown) of load beam 120. The location of actuators 143 can be at any suitable location on actuator arm 122 or load beam 120.

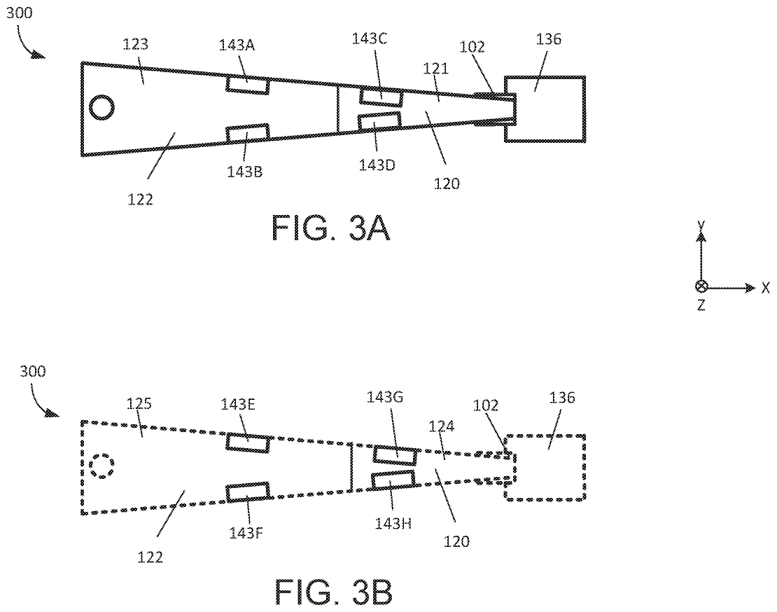

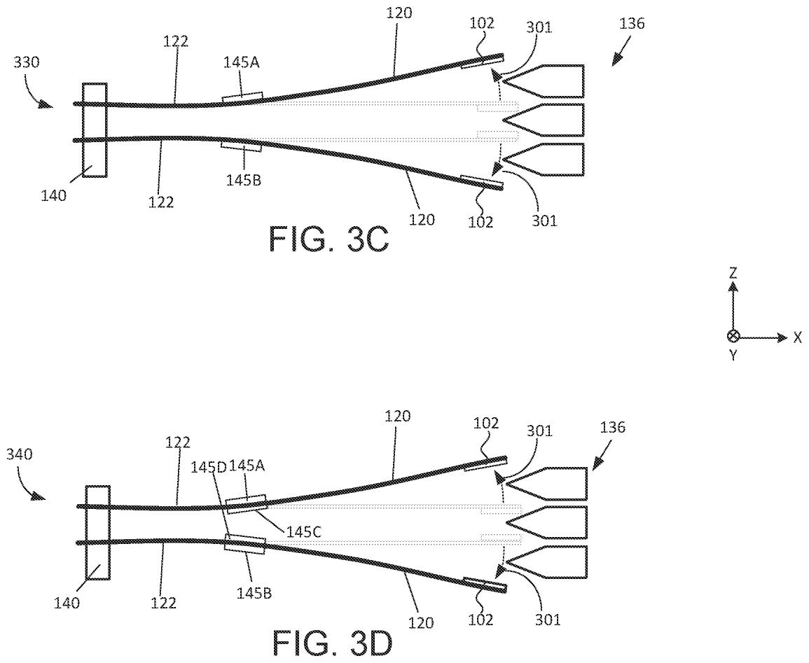

FIG. 3A is a schematic illustration of a top-down view of an example head stack assembly, according to various aspects of the present disclosure. FIG. 3B is a bottom view of an example head stack assembly, according to various aspects of the present disclosure. FIGS. 3C and 3D are schematic illustrations of side views of example head-stack assemblies, according to various aspects of the present disclosure.

FIGS. 3A and 3B include head stack assembly 300. Head stack assembly 300 is an example of head stack assembly 138 of FIGS. 1 and 2. Head stack assembly 300 includes actuator arm 122, load beam 120, recording head support ramp assembly 136, recording heads 102 and actuators 143A, 143B, 143C, 143D, 143E, 143F, 143G and 143H (collectively, actuators 143). FIGS. 3A and 3B schematically illustrate example locations of actuators 143 on actuator arm 122 and load beam 120.

In the example of FIG. 3A HSA 300 includes actuators 143A and 143B disposed on top surface 123 of actuator arm 122. HSA 300 includes actuators 143C and 143D disposed on top surface 121 of load beam 120. In the example of FIG. 3B HSA 300 includes actuators 143E and 143F disposed on bottom surface 125 of actuator arm 122. HSA 300 also includes actuators 143G and 143H disposed on bottom surface 124 of load beam 120, as illustrated in FIG. 3B. Any combination of actuators 143 on any of top surfaces (121 and 123) of load beam 120 and actuator arm 122 or bottom surfaces (124 and 125) of load beam 120 and actuator arm 122 may be used. For example, load beam 120 may include any number of actuators between 1 and 4 actuators, though in some scenarios, more than 4 actuators may be included. Similarly, actuator arm 122 may include any number of actuators between 1 and 4 actuators, though in some scenarios, more than 4 actuators may be included. In some examples, actuators 143 may be disposed only on top surface 121 of load beam 120. In another example, actuators 143 may be disposed only on top surface 123 of actuator arm 122. In yet another example, actuators 143 may be disposed only on bottom surface 124 of load beam 120 or actuators 143 may be disposed only on bottom surface 125 of actuator arm 122. In a further example, actuators 143 may be disposed on top surface 121 of load beam 120 and on top surface 123 of actuator arm 122. In still further examples, actuators 143 may be disposed on bottom surface 124 of load beam 120 and on bottom surface 125 of actuator arm 122. Though FIGS. 3A and 3B illustrate HSA 300 comprising a total of 8 actuators (actuators 143A-H), it is understood that any combination of actuators on any surface of load beam 120 and/or actuator arm 122 may be used.

FIGS. 3C and 3D are schematic illustrations of side views of example head-stack assemblies, according to various aspects of the present disclosure. Head stack assembly 330 is an example of head stack assembly 138 of FIG. 1. Head stack assembly 330 includes elevator 140, actuator arms 122, load beams 120, recording head support ramp assembly 136, and recording heads 102. HSA 330 includes actuators 145A and 145B, disposed on actuator arms 122. In the example of FIG. 3D, HSA 340 includes actuators 145A, 145B, 145C and 145D disposed on actuator arms 122.

Vertical motion (e.g., in the z-direction) of recording heads 102 can, in some examples, be achieved by inducing elevator motion. Actuators 145A, 145B, 145C and 145D can also be used for fine z-motion of recording heads 102. In the example where actuators 145A, 145B, 145C and 145D are piezoelectric actuators, applying a compression in the x-direction will induce movement of load beams 120 and actuator arms 122 in a z-direction, as illustrated by arrows 301 in FIG. 3C and FIG. 3D. Further examples of z-motion in an HGA may be found in U.S. application Ser. No. 17/728,425, filed on 25 Apr. 2022 and entitled “Adjusting HGA Z-height via HSA elevator using head/actuator feedback”, the contents of which are hereby incorporated by reference in its entirety.

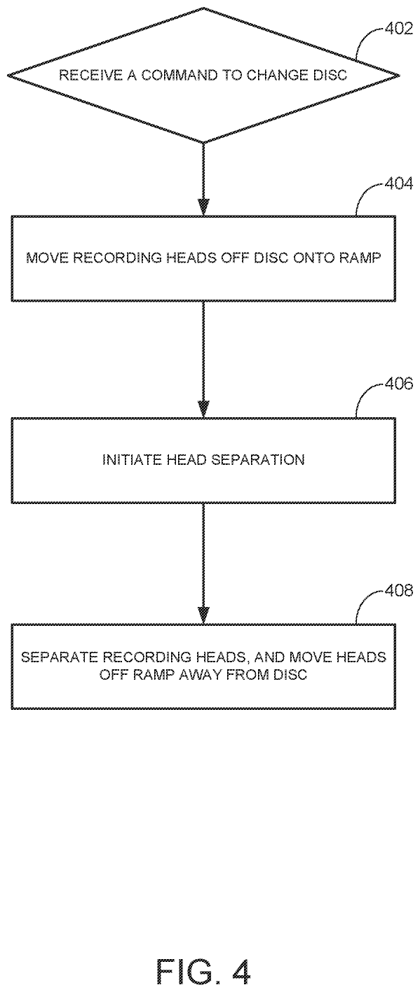

FIG. 4 shows a flow diagram illustrating an example set of steps of actuation of off-ramp z-motion in an elevator drive, according to various aspects of the present disclosure. FIG. 4 is described in reference to data storage device 100 of FIG. 1 and data storage device 200 of FIG. 2.

A command is received to change disc 104 (in step 402). Recording heads 102 are rotated away from recordable surface 105 and moved to recording head support ramp assembly 136 (in step 404). In general, in order to keep recording heads 102 from landing on discs 104 in a data storage device 100 when, for example, power is removed from data storage device 100 or when a change disc command is received, recording head support ramp assembly 136 is provided adjacent to OD 109 of discs 104. Recording head support ramp assembly 136 may also prevent recording heads 102 from colliding with outer edges of discs 104 during load and unload operations.

Following movement of recording heads 102 onto recording head ramp assembly 136, separation of recording heads 102 in a vertical direction relative to recordable surface 105 of disc(s) 104 is initiated (in step 406) by actuators 143. In some examples, actuators 143 may be piezoelectric actuators. Piezoelectric actuators convert an electrical signal into controlled physical displacements.

Actuators 143 deflect recording heads 102 in a vertical direction relative to recordable surface 105 of disc 104 while actuator arm 122 rotates recording heads 102 away from disc 104 (in step 408). Thus, recording heads 102 are moved away from disc 104 in an x-y plane as well as in a z-direction at approximately the same time. In some examples, deflecting recording heads 102 in a vertical direction relative to the recordable surface 105 of disc 104 can protect recording heads 102 from colliding with one another during off-ramp motion.

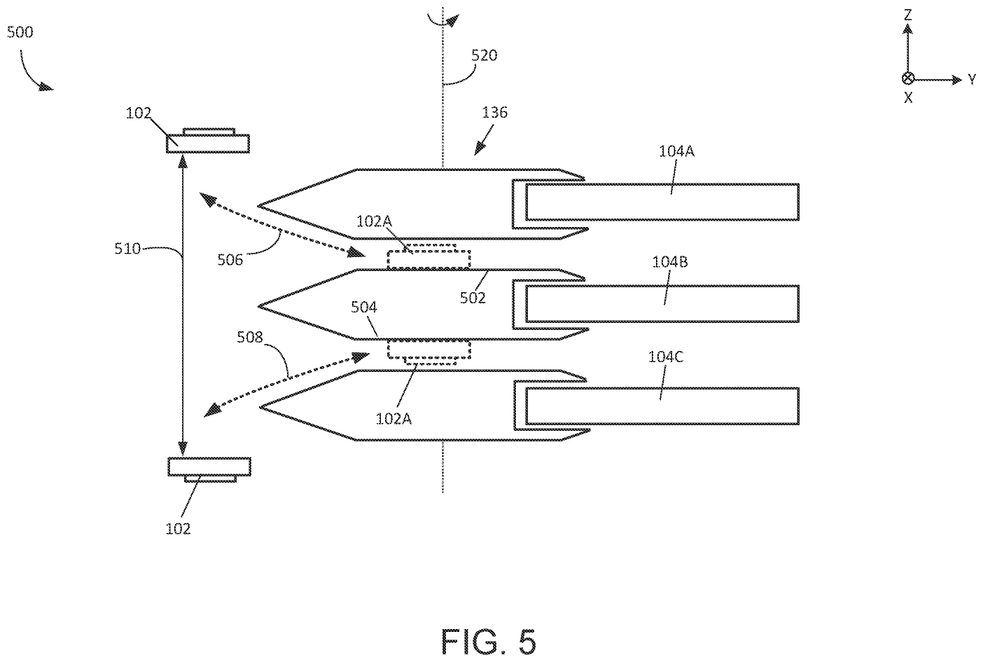

FIG. 5 is a simplified schematic illustration of an end-view of a portion of an example data storage device, according to various aspects of the present disclosure. In the example of FIG. 5, a portion of data storage device 100, 200 showing movement of recording heads 102 during actuation of off-ramp z-motion in an elevator drive is shown. Portion of data storage device 500 includes discs 104A, 104B and 104C (collectively discs 104), recording head support ramp assembly 136 and recording heads 102 and 102A. In the interest of simplification, several other elements of data storage device 100, 200 are not shown in FIG. 5.

In the example of FIG. 5, recording heads 102A are disposed on surfaces 502 and 504 of recording head support ramp assembly 136. Arrows 506 and 508 indicate the direction of movement of recording heads 102A following initiation of separation of recording heads 102. Arrows 506 and 508 illustrate movement of recording heads 102 away from recording head support ramp assembly 136 and away from discs 104. Vertical movement of recording heads 102 relative to recordable surface 105 of disc(s) 104 is initiated by actuators 143 (e.g., actuators 143 of FIG. 1). Actuator arm 122 (not shown in FIG. 5) moves recording heads 102A in a horizontal direction. Recording heads 102 in their final position are shown with a z-separation indicated by distance 510. The separation between recording heads 102 is between about 1 mm and about 2 mm in order to ensure that the heads do not collide while off-disc.

In some scenarios, and in cases where recording head support ramp assembly 136 includes rotatable portion of ramp 136b (not shown in FIG. 5), recording head support ramp assembly 136 may rotate around axis 520. Following rotation of recording head support ramp assembly 136 around axis 520, recording heads 102A may move in a z-direction without horizontal movement of heads via activator arm 122.

Various examples have been presented for the purposes of illustration and description. These and other examples are within the scope of the following claims.

What is claimed is:

1. A data storage device comprising:
at least one data storage disc having a recordable surface;
a head stack assembly comprising:
an actuator mechanism;
at least one recording head supported by a suspension assembly, wherein the suspension assembly includes a load beam and an actuator arm; and
at least one actuator disposed on at least one surface of at least one of the load beam or the actuator arm, wherein the at least one actuator is configured to deflect the at least one recording head in a vertical direction relative to the recordable surface of the at least one data storage disc.

2. The data storage device of claim 1, wherein the data storage device comprises a least one data storage disc having an outer diameter.

3. The data storage device of claim 1, wherein the actuator arm is a rotatable actuator arm.

4. The data storage device of claim 1, wherein the data storage device comprises a ramp for supporting the at least one recording head when the at least one recording head is moved away from a data storage disc.

5. The data storage device of claim 4, wherein the ramp includes a stationary portion and a moveable portion and wherein the moveable portion moves the rotatable actuator arm in a z-direction.

6. The data storage device of claim 1, wherein the at least one actuator is formed from a piezoelectric material.

7. The data storage device of claim 1, wherein the at least one actuator is formed from a shape memory alloy.

8. The data storage device of claim 1, wherein the at least one actuator is formed from a thermal bimetallic material.

9. The data storage device of claim 1, wherein the at least one actuator is configured to deflect the at least one recording head in a cross-track direction.

10. A head stack assembly comprising:
an actuator mechanism;
at least one recording head supported by a suspension assembly, wherein the suspension assembly includes a load beam and an actuator arm; and
at least one actuator disposed on at least one surface of at least one of the load beam or the actuator arm, wherein the at least one actuator is configured to deflect the at least one recording head in a vertical direction relative to a recordable surface of at least one data storage disc.

11. The head stack assembly of claim 10, wherein the actuator arm is a rotatable actuator arm.

12. The head stack assembly of claim 10, wherein the head stack assembly comprises a ramp for supporting the at least one recording head when the at least one recording head is moved away from a data storage disc.

13. The head stack assembly of claim 12, wherein the ramp includes a stationary portion and a moveable portion and wherein the moveable portion moves the rotatable actuator arm in a z-direction.

14. The head stack assembly of claim 10, wherein the at least one actuator is formed from a piezoelectric material.

15. The head stack assembly of claim 10, wherein the at least one actuator is formed from a shape memory alloy.

16. The head stack assembly of claim 10, wherein the at least one actuator is formed from a thermal bimetallic material.

17. The head stack assembly of claim 10, wherein the at least one actuator is configured to deflect the at least one recording head in a cross-track direction.

18. A method of actuation of off-ramp z-motion in an elevator drive, the method comprising the steps of:
receiving a command to change a disc;
moving at least one recording head away from a disc surface to a recording head support ramp assembly;
deflecting the at least one recording head in a vertical direction relative to the disc surface, wherein deflecting the at least one recording head in a vertical direction relative to the disc surface is performed by at least one actuator disposed on at least one surface of at least one of a load beam or an actuator arm; and
rotating the at least one recording head away from the disc.

19. The method of claim 18, wherein the at least one actuator is formed from a piezoelectric material.

20. The method of claim 18, wherein the at least one actuator is formed from a shape memory alloy.
